(19) United States
(12) Patent Application Publication
(10) Pub. No.: US 2006/0283956 A1
(43) Pub. Date: Dec. 21, 2006

(54) Retractable label for computer technical information

(75) Inventors: Vincent C. Conzola, Raleigh, NC (US); Gerard F. Muenkel, Raleigh, NC (US)

Correspondence Address: CARDINAL LAW GROUP, 1603 ORRINGTON AVENUE, SUITE 2000, EVANSTON, IL, 60201, US

(73) Assignee: International Business Machines Corporation, Armonk, NY (US)

(21) Appl. No.: 11/155,222

(22) Filed: Jun. 17, 2005

(51) Int. Cl. G06K 19/00

(52) U.S. Cl. 235/487

(57) ABSTRACT

A computer hardware technical information storage device includes a flexible label movable between an open scroll and a closed scroll configuration. The flexible label includes an attachment end for affixing to a base member. The flexible label includes technical information displayed on at least one surface of the flexible label.

### FIELD OF INVENTION

The present invention generally relates to computer technical information labels. The present invention specifically relates to a retractable label for computer technical information.

### BACKGROUND OF THE INVENTION

Existing computer information labels convey a variety of information to a user. This information includes hardware safety information, hardware service information, agency information, information configured for computer interpretation, IP addresses, host names, contact information, warranty information, serial number, model number, part numbers, replacement part numbers, manufacturer information, and usage instructions, among other information. Typically, a great deal of additional information is included in books and manuals that accompany a computer system when sold. The purchaser must then keep track of the manuals, in the event that the user requires access to this information.

To alleviate the problem of misplaced or unavailable manuals, it is desirable to convey a great deal of information on labels affixed to the computer chassis. However, as computer hardware miniaturizes, chassis size decreases and the footprint of a label can interfere with air vents and cable connection space, undesirably limiting the chassis design due to a large label. Furthermore, with the miniaturization of hardware, power consumption often increases, as well as an undesirable increase in heat radiation from the hardware, making additional air vents in the chassis beneficial to the overall hardware design.

It is therefore a challenge for the computer industry to develop techniques for providing computer hardware information while reducing the size of the footprint of the label.

### SUMMARY OF THE INVENTION

A first embodiment of the present invention is a computer hardware technical information storage device including a flexible label movable between an open scroll and a closed scroll configuration. The flexible label includes an attachment end for affixing to a base member. The flexible label includes technical information displayed on a label surface.

A second embodiment of the present invention is a method for providing computer hardware technical information for a computer. The method includes storing computer technical information in a closed scroll configuration on a computer; and displaying the computer technical information in an open scroll configuration.

A third embodiment of the present invention is a system for providing computer hardware technical information for a computer. The system includes means for storing computer technical information in a closed scroll configuration on a computer; and means for displaying the computer technical information in an open scroll configuration.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates an exemplary embodiment of a retractable label for computer technical information in accordance with the present invention;

FIG. 2 illustrates another exemplary embodiment of a retractable label for computer technical information in accordance with the present invention;

FIGS. 3A and 3B illustrate embodiments of a grasping tab used in conjunction with a retractable label for computer technical information in accordance with the present invention;

FIGS. 4A, 4B, and 4C illustrate another exemplary embodiment of a retractable label for computer technical information in accordance with the present invention;

FIGS. 5A and 5B illustrate another exemplary embodiment of a retractable label for computer technical information in accordance with the present invention;

FIGS. 6A, 6B, and 7-9 illustrate exemplary embodiments of a base member used in conjunction with a retractable label for computer technical information in accordance with the present invention;

FIG. 10 illustrates one embodiment of a method for providing computer hardware technical information for a computer, in accordance with the present invention;

FIG. 11 illustrates one embodiment of a method for storing computer hardware technical information for a computer, in accordance with the present invention;

FIG. 12 illustrates one embodiment of a method for securing a flexible label containing computer hardware technical information for a computer, in accordance with the present invention; and

FIG. 13 illustrates one embodiment of a method for displaying computer hardware technical information in an open scroll configuration, in accordance with the present invention.

### DETAILED DESCRIPTION OF THE PRESENT INVENTION

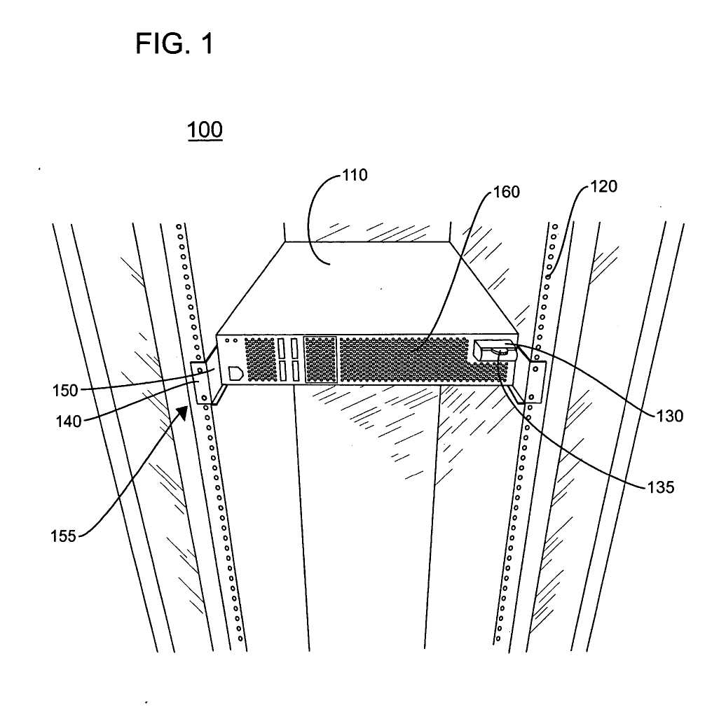

FIG. 1 illustrates one embodiment of a system 100 including a flexible label for computer technical information in accordance with the invention. System 100 includes computer hardware 110 and rack system 120. In the illustrated embodiment, hardware 110 is configured for rack mounting, although other configurations are envisioned, and included within the scope of this disclosure. Hardware 110 is any appropriate computer device, including a personal computer, server, drive assembly or other computer device contained within a housing. Rack system 120 includes a plurality of screw holes for supporting hardware 110 in a number of positions. FIG. 1 illustrates hardware 110 supported in rack system 120 using bracket 155. Bracket 155 includes a connection portion 150 for connecting bracket 155 to hardware 110 and attachment portion 140 for attaching bracket 155 to rack system 120. Hardware 110 includes mounting surface 160 on the housing for hardware 110. In one embodiment, mounting surface 160 is an interior surface of the housing for hardware 110. In other embodiments, the mounting surface is a front of the housing, or the back of the housing. The device may be mounted horizontally or vertically, or at an angle. The device may be mounted behind a front bezel. In other embodiments, multiple devices are mounted to a single rack system or to a single hardware device.

System 100 includes base member 130 configured for attachment to a mounting surface. As shown in FIG. 1, base member 130 is attached to mounting surface 160. Grasping tab 135 is shown extending from base member 130. A flexible label is not illustrated in FIG. 1 because the flexible label is in a closed scroll configuration, wherein the only portion of the flexible label that is visible outside the base member 130 is grasping tab 135.

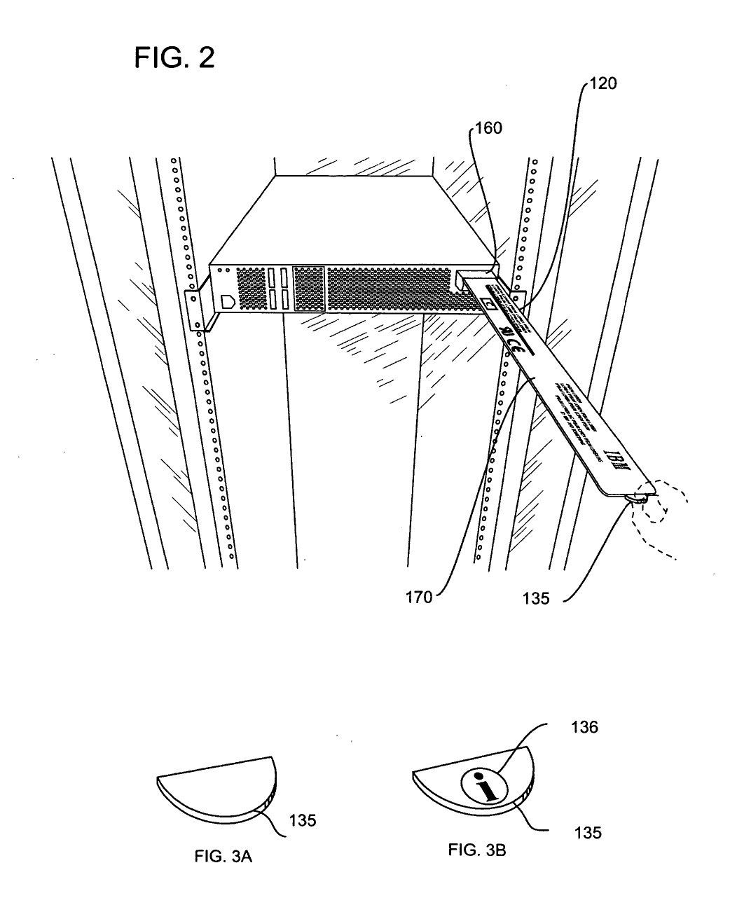

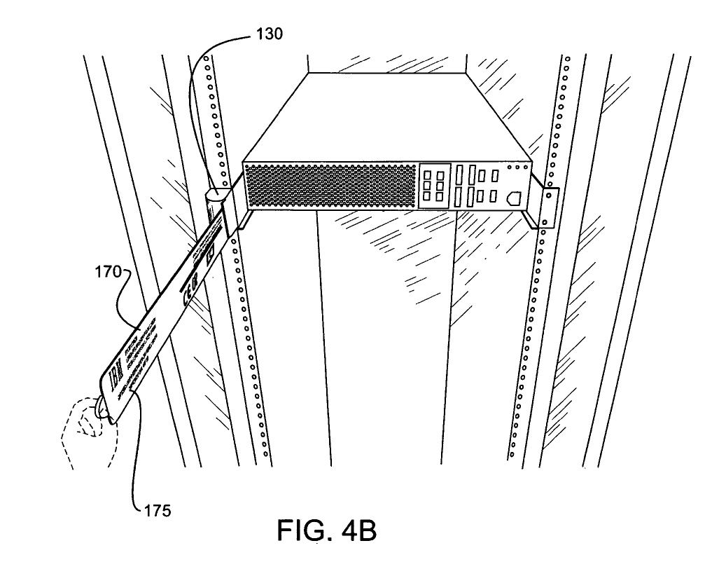

FIG. 2 illustrates flexible label 170 in an open scroll configuration and extending between the grasping tab 135 and base member 130. Technical information 175 (shown in FIG. 4B) is displayed on at least one surface of flexible label 170. Flexible label 170 is moveable between the closed scroll configuration depicted in FIG. 1, and the open scroll configuration depicted in FIG. 2, as well as any number of intermediate configurations exposing a greater or lesser portion of a surface of the flexible label 170 in which more or less technical information 175 is revealed to a user. Flexible label 170 is attached to a grasping tab at one end in one embodiment. Flexible label 170 includes an attachment end for affixing to a base member opposite the end that may be attached to a grasping tab. Flexible label 170 may be substantially opaque such that information displayed on one side of the label is not visible when viewed from the other side of the label, or substantially transparent such that information displayed on one side of the label is visible when viewed from the other side of the label. Flexible label 170 may be as wide or narrow as design constraints allow, and may be as long or as short as necessary to contain the desired level of information based on a design decision. The flexible label may be made of any thin, flexible, durable material that is configured to receive indelible images of information and be rolled onto, for example, a rod.

Technical information 175 (FIG. 4B) may include any information relevant to use, operation, and/or repair of hardware 110. For example, technical information 175 includes, without limitation, hardware safety information, hardware service information, agency information, information configured for computer interpretation, IP addresses, host names, contact information, warranty information, serial number, model number, part numbers, replacement part numbers, manufacturer information, and usage instructions. For example, technical information may be inscribed upon flexible label in a fashion not comprehensible to a human eye, such as a bar code, or another machine-readable coding scheme. In such an embodiment, the information is deciphered using a standard or customized technical information reader (not shown) that may be affixed to the storage rack, or be a free standing device. In one embodiment, the most important technical information is printed closest to the grasping tab, while less important technical information is printed closer to the attachment portion of flexible label 170. Importance of information may be defined in any appropriate fashion. In another embodiment, flexible label 170 includes at least one note portion configured to receive notes from technicians or users in a permanent (i.e. written with a pen) or semi-permanent fashion (i.e. written with, for example, a dry-erase marker). The note portion, for example, may be used to track service histories or pass information from technician to technician.

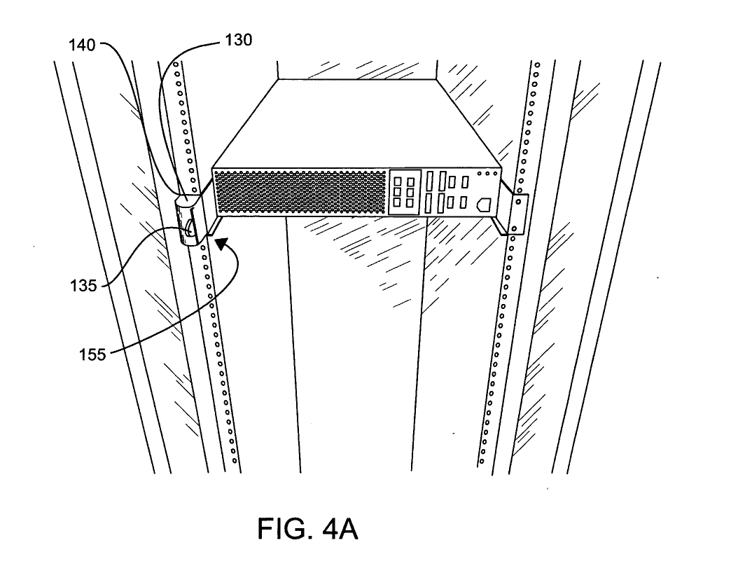

FIG. 3A illustrates one embodiment of a grasping tab in accordance with the invention. Grasping tab 135 is configured to be affixed to a flexible label for controlling the configuration of the flexible label between an open scroll and closed scroll configuration. FIG. 3B illustrates another embodiment of a grasping tab in accordance with the invention. As illustrated in FIG. 3B, grasping tab 135 includes an information indicator 136. An information indicator is an icon or other indication that further information is available by use of the grasping tab 135.

FIGS. 4A and 4B illustrate another embodiment of the invention, wherein base member 130 is affixed to bracket 155 at attachment portion 140. Although not illustrated, those of ordinary skill in the art will readily recognize that the base member 130 may be affixed to the connection portion 150 in other embodiments of the invention. FIG. 4A illustrates flexible label 170 in the closed scroll configuration, while FIG. 4B illustrates flexible label 170 in the open scroll configuration, with technical information 175 displayed on one surface of flexible label 170. FIG. 4C illustrates the embodiment illustrated in FIG. 4B, and illustrating technical information 175 displayed on another surface of flexible label 170. As shown in FIGS. 4A, 4B, and 4C, technical information 175 may be located on one surface of flexible label 170, two surfaces of flexible label 170 (e.g. front and back), or any number of surfaces of flexible label 170.

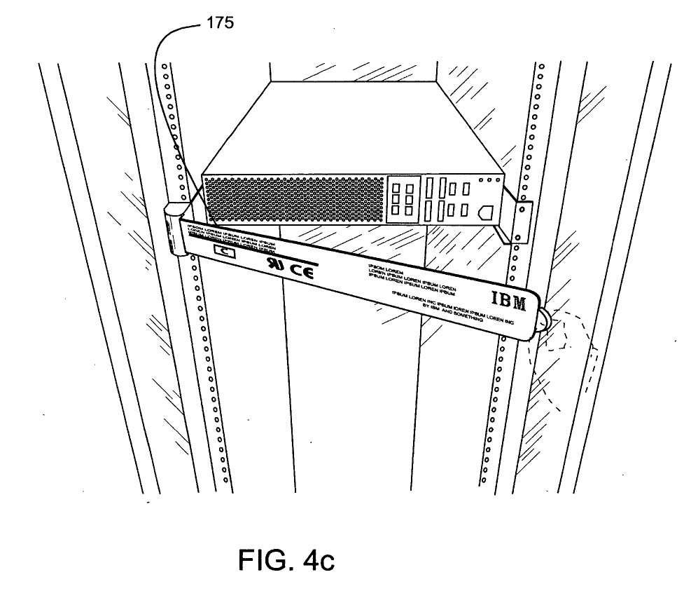

FIGS. 5A and 5B illustrate yet another embodiment of the invention wherein base member 130 is configured to extend through the housing for hardware 110. FIG. 5A illustrates flexible label 170 in the closed scroll configuration, while FIG. 5B illustrates flexible label 170 in the open scroll configuration, with technical information 175 displayed on one surface of flexible label 170. FIGS. 5A and 5B illustrate an embodiment of the invention wherein the base member comprises the computer housing. In one embodiment, the computer housing is configured for use in a computer equipment rack.

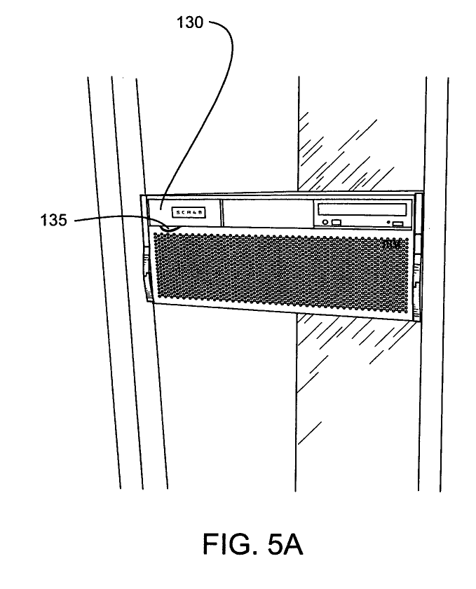

FIG. 6A illustrates a side view cross section of base member 130 including a rod 650. Rod 650 is configured to rotate about pin 660 to wind and unwind flexible label 170 as flexible label travels between the open scroll and closed scroll configurations. The flexible label winds around the circumference of rod 650. Rod 650 is rotatably attached to a computer housing in one embodiment. In another embodiment, rod 650 is rotatably attached to base member 130. In one embodiment, rod 650 is configured as a cylinder, although other geometries are envisaged.

FIG. 6B illustrates a side view cross section of another embodiment of base member 130 including a rod 650. As shown in FIG. 6B, base member 130 includes a flexible label 170 extending from its position encircling the rod 650, through the body of the housing 130, and culminating in grasping tab 135.

FIG. 7 illustrates one embodiment of a base member 130 in accordance with one aspect of the invention. Handle 770 is attached to drive rotation of rod 650 in the embodiment illustrated in FIG. 7. Any appropriate configuration of a handle may be implemented in accordance with the invention.

FIG. 8 illustrates one embodiment of a base member 130 in accordance with one aspect of the invention. Spring loading mechanism 880 is attached to rod 650 in this embodiment. Spring loading mechanism 880 is configured to bias rod 650 such that flexible label is in its open scroll or closed scroll configurations. In one embodiment, spring loading mechanism 880 is configured in a similar fashion as a household window shade. In one embodiment, spring loading mechanism includes a system of simple pins and hooks to operably maneuver spring loading mechanism 880 to operate in a predictable and desirable fashion.

FIG. 9 illustrates one embodiment of a base member 130 in accordance with one aspect of the invention. FIG. 9 further illustrates ratcheting mechanism 985 configured to ratchet flexible label 170 between the open and closed scroll configurations, as well as any intermediate configuration. In one embodiment, ratcheting mechanism 985 is used with a spring loading mechanism 880 as disclosed with reference to FIG. 8.

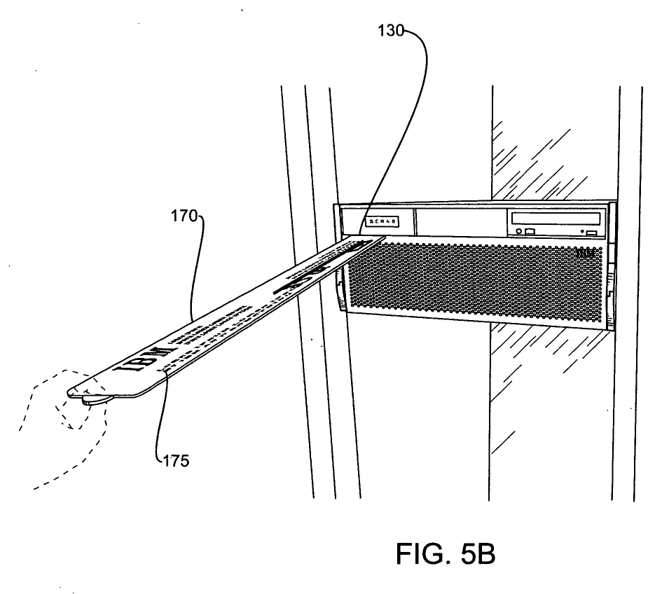

FIG. 10 illustrates one embodiment of a method 1000 for providing computer hardware technical information for a computer, in accordance with the present invention. Method 1000 starts at 1005.

Computer technical information, such as technical information 175 is stored in a closed scroll configuration at step 1010. After storing the technical information, method 1000 displays the computer technical information in an open scroll configuration at step 1015. In one embodiment, the computer technical information is displayed in the open scroll configuration in a locked position configured to allow the computer technical information to unlock to return to the closed scroll configuration. Method 1000 ends at 1020.

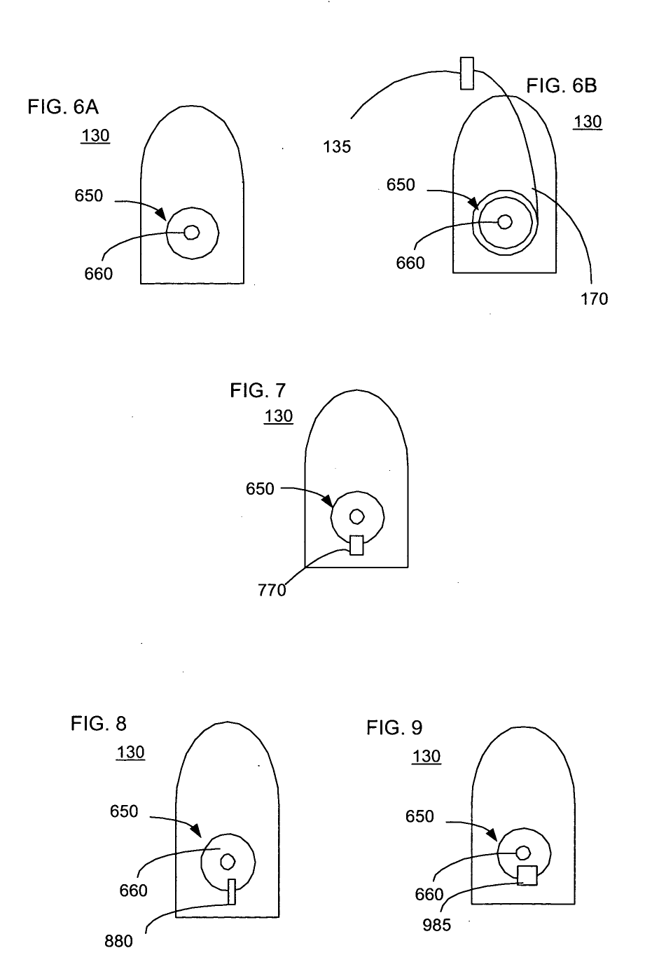

FIG. 11 illustrates one embodiment of a method 1100 for storing computer hardware technical information for a computer, in accordance with the present invention. Method 1100 starts at 1105. Computer technical information, such as technical information 175 is stored in a closed scroll configuration at step 1110. A flexible label, such as flexible label 170, containing technical information such as technical information 175 is secured in a closed scroll configuration to a computer at 1120. Method 1100 ends at 1130.

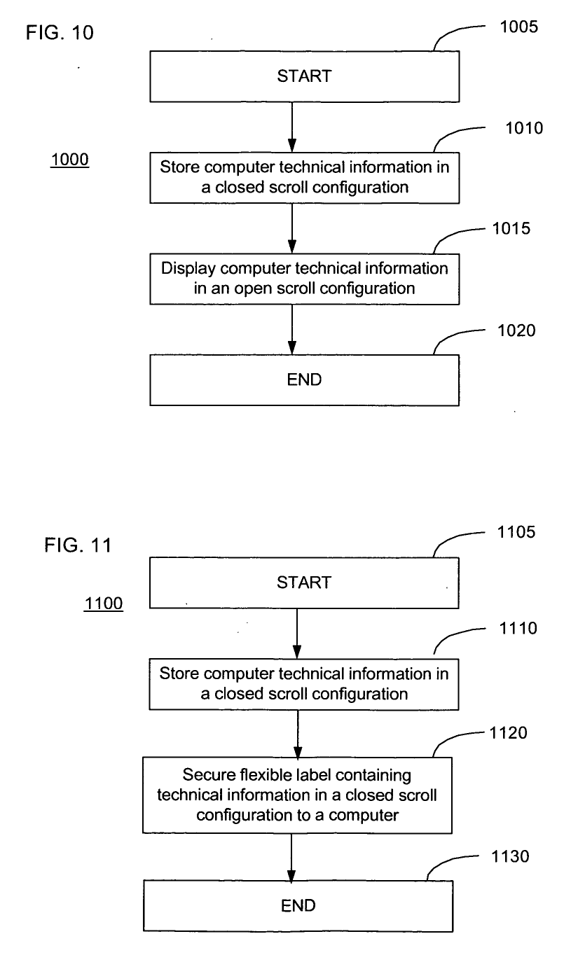

FIG. 12 illustrates one embodiment of a method for securing a flexible label containing computer hardware technical information for a computer. Method 1200 starts at 1205.

A flexible label, such as flexible label 170, containing technical information such as technical information 175 is secured in a closed scroll configuration to a computer at 1210. One end of the flexible label is fixedly attached to a rod, such as rod 650, and the rod is rotatably attached to a computer housing at 1220. Method 1200 ends at 1230.

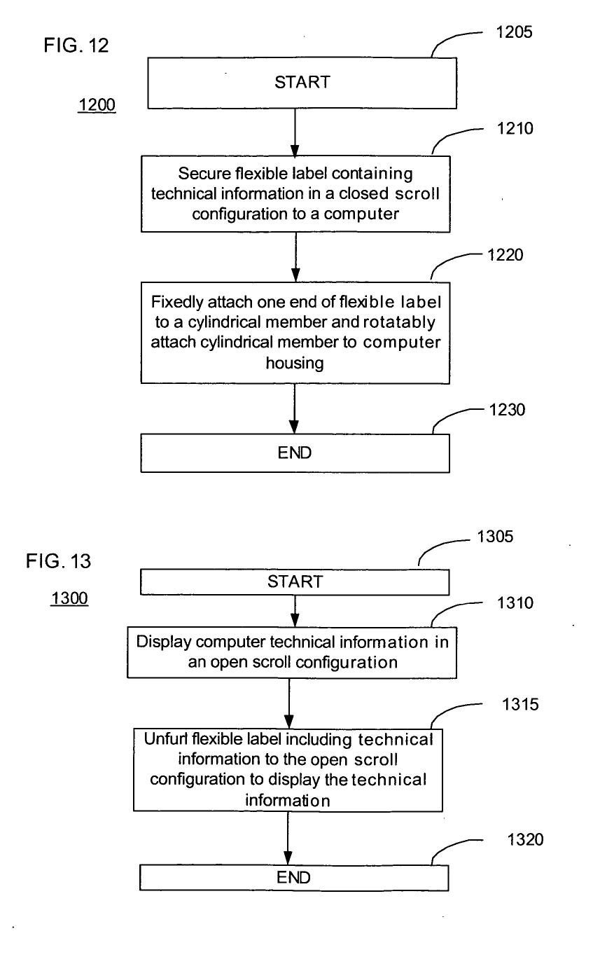

FIG. 13 illustrates one embodiment of a method for displaying computer hardware technical information in an open scroll configuration. Method 1300 starts at 1305.

Computer technical information is displayed in an open scroll configuration at 1310. The flexible label is unfurled to the open scroll configuration to display the technical information at 1315. Method 1300 ends at 1320.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. An information storage device, comprising:
a rod;
a flexible label movable between an open scroll and a closed scroll configuration, the flexible label including an attachment end coupled to the rod, the flexible label configured to display information on a label surface; and
a base member coupled to the rod.

2. The device of claim 1 wherein the base member is configured to be to a computer housing.

3. The device of claim 2 wherein the cylinder member comprises a spring loading mechanism configured for controlled actuation between the open scroll and closed scroll configurations.

4. The device of claim 2 wherein the cylinder member comprises a handle configured to rotate the cylinder member about a center axis.

5. The device of claim 1 wherein the base member is mounted on a computer housing.

6. The device of claim 5 where the computer housing is configured for use in a computer equipment rack.

7. The device of claim 1 wherein the label includes a grasping tab.

8. The device of claim 6 wherein the grasping tab includes an information indicator.

9. The device of claim 1 wherein the technical information comprises at least one type of information selected from the group consisting of hardware safety information, hardware service information, agency information, information configured for computer interpretation, IP addresses, host names, contact information, warranty information, serial number, model number, part numbers, manufacturer information, and usage instructions.

10. A method for providing computer hardware technical information for a computer, the method comprising:
storing computer technical information in a closed scroll configuration on a computer;
displaying the computer technical information in an open scroll configuration.

11. The method of claim 9 wherein storing computer technical information comprises securing a flexible label containing technical information in the closed scroll configuration to a computer.

12. The method of claim 10 wherein securing a flexible label comprises fixedly attaching one end of the flexible label to a cylinder member, and rotatably attaching the cylinder member to a computer housing.

13. The method of claim 1, wherein the cylinder member is spring loaded.

14. The method of claim 9 wherein displaying comprises unfurling a flexible label including the technical information to the open scroll configuration to display the technical information.

15. The method of claim 9 further comprising:
locking the computer technical information in an open scroll configuration.

16. The method of claim 15 further comprising:
unlocking the computer technical information to return to the closed scroll configuration.

17. A system for providing computer hardware technical information for a computer, the system comprising:
means for rotatably storing and displaying computer technical information between a open scroll and closed scroll configuration
